(19) United States
(12) Patent Application Publication
(10) Pub. No.: US 2012/0126153 A1
(43) Pub. Date: May 24, 2012

(54) LIGHT GRID

(75) Inventor: Arnold Schönleitner, Purkersdorf (AT)

(73) Assignee: Leuze Electronic Gmbh, Owen/Teck (DE)

(21) Appl. No.: 13/301,417

(22) Filed: Nov. 21, 2011

(30) Foreign Application Priority Data
Nov. 24, 2010 (DE) 10 2010 052 450.6

(51) Int. Cl. H01J 40/14

(52) U.S. Cl. 250/578.1

(57) ABSTRACT

A light grid detects objects in a monitored area. The grid includes a number of transmitters that emit light rays pulses. A number of receivers, corresponding to the number of transmitters, receive the light rays. Respectively one transmitter is assigned to one receiver to define a light axis. With a clear monitoring area, the light rays emitted by the transmitter impinge on the corresponding receiver. The transmitters and the corresponding receivers are activated cyclically and individually, one after another. An evaluation unit generates a switching signal in dependence on the signals received at the receivers. A control unit coupled between the receivers and the evaluation unit eliminates interfering light shares in the signals received at the receivers. The control unit is deactivated during time intervals in which the transmitters emit transmitting pulses.

### CROSS-REFERENCE TO RELATED APPLICATION

This application claims the priority of the German Patent Application No. 10 2010 052 450.6, filed on Nov. 24, 2010, the subject matter of which is incorporated herein by reference.

### BACKGROUND OF THE INVENTION

The invention relates to a light grid for detecting objects in a monitored area with the aid of a predetermined number of transmitters for emitting light rays in the form of transmitting pulses, as well as a corresponding number of receivers for receiving a matching number of light rays. To form a light axis, respectively one transmitter is assigned to one receiver in such a way that if the monitored area is clear, the light rays emitted by a transmitter impinge on the associated receiver, wherein the transmitters and the associated receivers for the light axes are activated cyclically, one after another. A switching signal is then generated in an evaluation unit in dependence on the signals received at the receiver.

The individual activation of the light axes, in a known manner known per se, occurs with the aid of switching means that are assigned to the transmitters for individually activating these transmitters, as well as the switching means assigned to the receivers for individually activating these receivers. The switching means on the transmitting side and those on the receiving side are optically synchronized via the light rays of the light grid. A light axis can be provided, for example, which differs characteristically from the transmitting pulses of all the other light axes. The transmitting pulses of said light axis are then used for the optical synchronization of the transmitter and receiver activation.

The coupling capacitors of known light grids are arranged downstream of the receivers. These coupling capacitors function to eliminate from the signals received at the receivers the interfering light shares which are caused by impinging continuous wave (CW) light.

However, one disadvantage of this type of arrangement is that signal jumps occur in the receiving signals when realizing a serial activation of the individual receivers because the coupling capacitors are still partially charged. These signal jumps can be higher by factors of up to 1000 than the respective useful signal shares and can thus considerably distort the receiving signals, thereby causing detection errors.

The document DE 39 00 562 A1 describes a receiver amplifier in which the direct voltage share is compensated with the aid of a low-pass feedback. The band width of the feedback network is dimensioned such that the CW light is securely suppressed but with enough inertia (low cut-off frequency), so that short useful light pulses can be amplified without problem.

The document U.S. Pat. No. 6,956,439 B1 describes a control unit and a continuous-wave (CW) light compensation with a current source, wherein a low pass filter is used for separating the CW light and the alternating useful light.

The document EP 1 319 965 B1 describes a device provided with a differential and repeater amplifier for the CW light compensation.

The document DE 197 30 333 C1 describes a differential amplifier, comprising a control circuit with low-pass filter, which causes the readjustment to be slow enough, so that the useful signal is attenuated only slightly.

To be sure, no coupling capacitors are used for the systems disclosed in the aforementioned documents. However, the low-pass filters required for the control circuit must be correspondingly slow, so as not to attenuate the useful signal, meaning that a jump in the CW light cannot be stabilized fast enough.

The Infrascan 4000 light grid, manufactured by the company Sitronic, is known and comprises a separate amplifier for each receiving element. To be sure, this will correct the problem during the switching to a different light axis, but the expenditure increases with each light axis.

### SUMMARY OF THE INVENTION

It is therefore an object of the present invention to provide a light grid which can robustly resist interfering influences while requiring little structural expenditure.

The above and other objects are achieved according to the invention by the provision of a light grid for detecting objects in a monitored area, which in at least one embodiment, comprises a specified number of transmitters for emitting light rays in the form of transmitting pulses, as well as a matching number of receivers for receiving a corresponding number of light rays, wherein respectively one transmitter is assigned to one receiver for forming a light axis. If the monitored area is clear, the light rays emitted by the transmitter impinge directly on the associated receiver. The transmitters and the receivers which form the light axes are activated separately and cyclically, one after another. A switching signal is generated in an evaluation unit in dependence on the signals received at the receiver. A control unit is provided for eliminating the interfering light shares in the signals received at the receivers. The control unit is deactivated during the time intervals in which the transmitters emit transmitting pulses.

An advantage of the light grid according to the invention is that no coupling capacitors are needed for eliminating interfering signal shares caused by CW light which impinges on the receiver. The jumps in the receiving signals caused by the coupling capacitors therefore do not occur when the receivers are activated individually, thereby avoiding any detection errors resulting from this.

According to the invention, the elimination of the interfering signal shares in the impinging CW light takes place in the control unit to which the receiving signals of the respectively activated receivers are conducted.

The control unit is activated only during the transmitting pauses for the transmitters, but not if a transmitter emits a transmitting pulse and a useful signal, meaning a received light pulse that must be evaluated, is thus generated in the associated, activated receiver.

Control operations which would lead to a distortion of the received signal are thus avoided, owing to the inertia of the control unit during the emission of the transmitting pulse and detection errors are securely prevented.

One advantage of the invention is that the switching arrangement on the receiving side requires a low structural expenditure, wherein only a few structural components in particular are needed. It is advantageous that no pre-amplifiers are required for amplifying the received signals.

### BRIEF DESCRIPTION OF THE DRAWINGS

These and other features and advantages of the invention will be further understood from the following detailed description of the embodiments with reference to the accompanying drawings, wherein:

FIG. 1a shows a schematic representation of a light grid;

FIG. 1b shows a block diagram of a first exemplary embodiment of a control and evaluation unit for the light grid according to FIG. 1;

FIGS. 2a-e show time graphs for the signals and the switching states associated with the arrangement shown in FIG. 2;

FIG. 3 shows a modified version of the arrangement according to FIG. 2;

FIG. 4 shows a modified version of the embodiment of a control unit according to FIG. 2; and

FIG. 5 shows a different modified version of the embodiment of a control unit according to FIG. 2.

### DETAILED DESCRIPTION

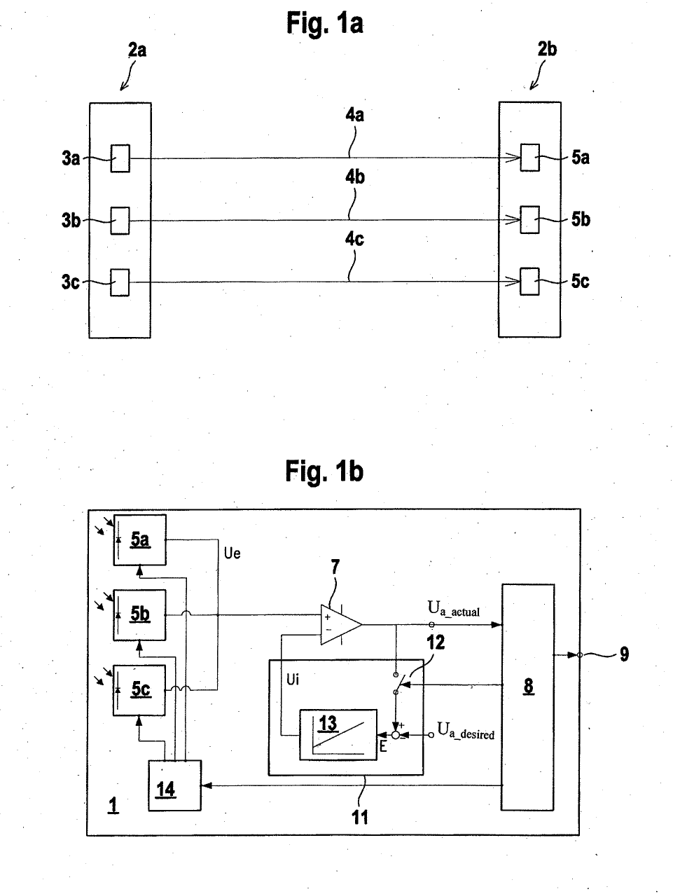

FIG. 1a shows a diagram of the configuration of the light grid 1 according to the invention. The light grid 1 comprises a transmitting unit 2a, positioned along a first edge of a monitored area, and a receiving unit 2b that is positioned along a second edge of the monitored area. Integrated into the transmitting unit 2a are several transmitters, in the present case three transmitters 3a, 3b and 3c, which emit light rays 4a, 4b and 4c in the form of transmitting pulses. The receivers 5a, 5b and 5c are integrated into the receiving unit 2b, wherein the number of receivers corresponds to the number of transmitters 3a, 3b and 3c. Respectively one transmitter 3a, 3b, 3c and one receiver 5a, 5b, 5c, which are arranged opposite each other, form a light axis so that if the monitored area is clear (as shown in FIG. 1a), the light rays 4a, 4b, 4c emitted by the transmitters 3a, 3b, 3c are conducted directly onto the receivers 5a, 5b and 5c.

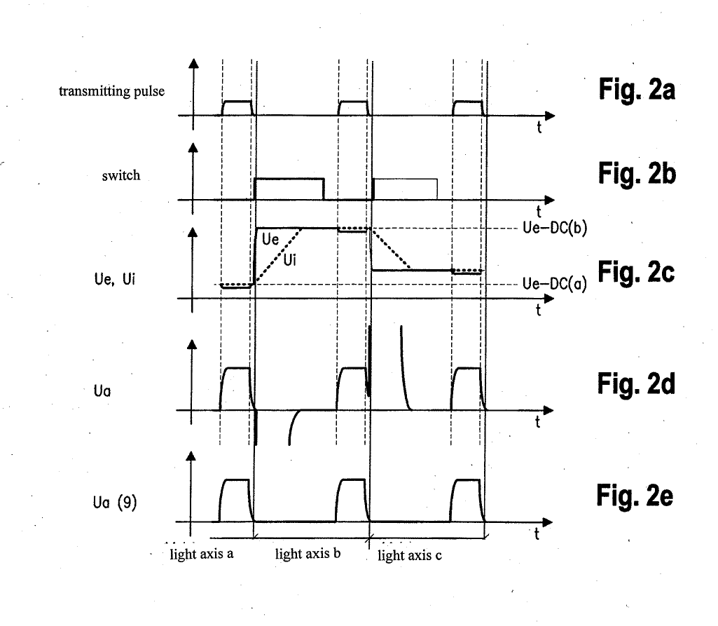

A control unit, which is not shown herein, is integrated into the transmitting unit 2a and functions to cyclically activate the individual transmitters 3a, 3b, 3c, one after another. A control and evaluation unit 8, shown and described in connection with FIGS. 2-5, is integrated into the receiver unit 2b for the cyclical activation of the individual receivers 5a, 5b and 5c, one after another, wherein this control and evaluation unit is also used to generate a binary switching signal from the received signals.

The operation of the transmitters 3a, 3b and 3c and the receivers 5a, 5b and 5c is synchronized optically via the light rays 4a, 4b and 4c, in a manner known per se, so that in all cases a transmitter 3a, 3b, 3c and a receiver 5a, 5b, 5c of a light axis are always activated simultaneously.

A threshold value evaluation of the receiving signals is realized in the control and evaluation unit 8 for generating the switching signal. The switching signal assumes the state “monitored area is clear” if none of the light axes is interrupted by an intervening object. The switching signal assumes the “object detected” state if at least one light axis is interrupted by an intervening object.

FIG. 1b shows an exemplary embodiment of a control and evaluation unit 8 for the light grid 1 according to FIG. 1a.

A switching logic 14 functions to individually activate the receivers 5a, 5b and 5c. The signals received at the respectively activated receiver 5a, 5b, 5c are conducted to a control unit 11 which functions to eliminate from the received signals the interfering signal shares caused by CW light which impinges on the receivers 5a, 5b and 5c.

The signal received at the respectively activated receiver 5a is conducted as input signal Uₑ to an amplifier 7 where the difference between the input signal Uₑ and an adjustment variable Uᵢ, which represents the share of the interfering light in the receiving signal, is amplified. The amplified output signal Uₐ_{_{—}}_{actual} is then conducted to an evaluation unit 8 where the switching signal is generated in dependence on the output signals Uₐ_{_{—}}_{actual} from all receivers 5a, 5b and 5c and is then emitted via a switching output 9. The control unit 11 furthermore comprises an integrator 13 and a switch 12 that is controlled by the evaluation unit 8 and is used to activate and deactivate the control unit 11.

The components of the control unit 11, shown in FIG. 1b, and the modes of operation for said components are explained with the aid of the time graphs shown in FIGS. 2a-2e.

The transmitting pulse time windows are shown in FIG. 2a, wherein respectively the transmitter 3a, 3b and 3c of a light axis is active in these time windows.

FIG. 2b shows the position of the switch 12. If the switch 12 is closed, the control unit 11 is activated and ensures that the output signal Uₐ_{_{—}}_{actual} is controlled to assume a desired value Uₐ_{_{—}}_{desired} (for the case shown herein that is the zero level) which forms the operating point for the following signal evaluation. As soon as the switch 12 is closed, a sample operation starts and the integrator 13 changes its output signal Uᵢ, as shown in FIG. 2c, which had been adapted to the CW light Uₑ-DC(a) of the light axis a. The controller output signal Uᵢ (the controller in this case preferably comprises an integrator share) approaches the value for the input signal Uₑ-DC(b) as a result of the CW light ratios of the light axis b, wherein this operation can take place extremely fast since the time constant for the controller does not influence the subsequent useful light amplification. Following the opening of the switch 12, the signal level Uᵢ is maintained (hold phase) and the useful light pulse generates the output signal Uₐ_{_{—}}_{actual} via the amplifier 7.

As shown in FIG. 2d, the output signal Uₐ_{_{—}}_{actual} moves during the transmitting pulse pause to the specified desired level (e.g. the zero potential). It can then be used without further high-pass filtering in the control and evaluation unit 8. If applicable, the output signal can also be blanked out in the control unit 8 during the transmitting pause, so as to make available only a useful signal at the terminal 9.

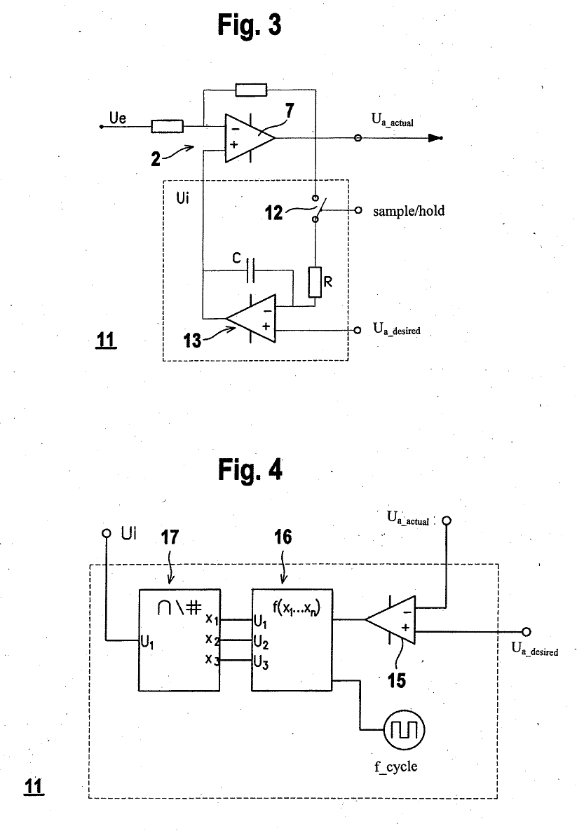

FIG. 3 shows a first embodiment of a subtracting element which is integrated into the amplifier 7 of the arrangement according to FIG. 1b and/or which forms this amplifier. An analog integrator 13 is used for the control operation, for which the time constant can be adjusted with the aid of the resistance R and the capacitor C. Since the voltage U_{desired} forms the reference for the integrator 13, this voltage also adjusts for Uₐ.

FIG. 4 shows a second embodiment of the control unit 11, wherein the output signal Uₐ is compared with the aid of a comparator 15 to a desired value for the operating point and a switch mechanism 16 (e.g. in the form of an up/down counter) readjusts a DA converter 17 in such a way that the output signal Uₐ approaches the desired operating value gradually but expeditiously.

The switch mechanism 16 assumes the function of the switch 12 in FIG. 1b, wherein the switch mechanism 16 comprises a control input. Depending on the control signal present at the control input, the switch mechanism 16 assumes two different states. In a compensating state, input information is accordingly transmitted by the switch mechanism 16 to its output and is emitted there. In a freeze state, this transfer of information is blocked.

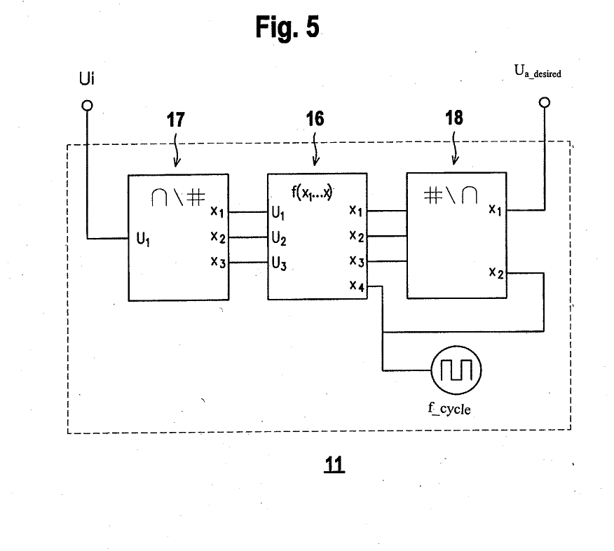

FIG. 5 shows a third embodiment of the control unit 11, wherein a request is posed via an AD converter 18 for the output signal Uₐ. The digital embodiment of the control unit 11 has the advantage that no drift or offset errors occur and that the switch 12 for freezing the operating point can be omitted. Here too, the switch mechanism 16 takes over the function of the switch 12, in the same way as for the embodiment according to FIG. 4. For the embodiment according to FIG. 5, the function of the compensator 15, illustrated in FIG. 4, is integrated into the AD converter.

It will be understood that the above description of the present invention is susceptible to various modifications, changes and adaptations, and the same are intended to be comprehended within the meaning and range of equivalents of the appended claims.

What is claimed is:

1. A light grid for detecting objects in a monitored area, comprising:
a number of transmitters that emit light rays in the form of transmitting pulses;
a number of receivers, corresponding to the number of transmitters to receive the light rays, wherein respectively one transmitter is assigned to one receiver to define a light axis, wherein with a clear monitoring area, the light rays emitted by each transmitter impinge on the corresponding receiver, wherein the transmitters and the corresponding receivers are activated cyclically and individually, one after another;
an evaluation unit to generate a switching signal in dependence on the signals received at the receivers; and
a control unit coupled between the receivers and the evaluation unit to eliminate interfering light shares in the signals received at the receivers, wherein the control unit is deactivated during time intervals in which the transmitters emit transmitting pulses.

2. The light grid according to claim 1, further comprising a switching logic to activate the individual receivers one after another, wherein the signals received at the respectively activated receiver are conducted to the control unit.

3. The light grid according to claim 2, further comprising a switch mechanism to activate the individual transmitters one after another, wherein the light axes function to optically synchronize the switch mechanism with the switching logic.

4. The light grid according to claim 1, further comprising a switch to activate and deactivate the control unit.

5. The light grid according to claim 4, wherein the switch is controlled by the evaluation unit.

6. The light grid according to claim 2, wherein pre-amplifiers are omitted between the switching logic and the receivers.
